(19) United States
(12) Patent Application Publication
(10) Pub. No.: US 2009/0091708 A1
(43) Pub. Date: Apr. 9, 2009

(54) PRESENTATION DEVICE FOR STEREOSCOPIC APPLICATIONS

(75) Inventor: Robert K. Greene, Los Alamos, NM (US)

Correspondence Address: HUSCH BLACKWELL SANDERS LLP, 720 OLIVE STREET, SUITE 2400, ST. LOUIS, MO, 63101, US

(73) Assignee: LOS ALAMOS NATIONAL SECURITY, LLC, Los Alamos, NM (US)

(21) Appl. No.: 11/868,375

(22) Filed: Oct. 5, 2007

(51) Int. Cl. G03B 21/00

(52) U.S. Cl. 353/7

(57) ABSTRACT

The invention provides for a visual presentation device configured to control a single spot in a stereoscopic image environment. The present invention comprises a light source assembly configured to provide a plurality of visible light beams for pointing the visible light beams at an object; a liquid crystal cell assembly including a pair of optical shutters, the liquid crystal cell assembly selectively transmitting fields of a field sequential image in response to a drive signal wherein each of the visible light beams emitted from the light source assembly passes through a respective optical shutter; a receiver mounted adjacent the liquid crystal cell assembly for receiving a synchronization signal; and a drive module coupled to the liquid crystal cell assembly and the receiver for generating the drive signal in response to the synchronization signal and supplying the drive signal to the liquid crystal cell assembly.

### STATEMENT REGARDING FEDERAL RIGHTS

This invention was made with government support under Contract No. DE-AC52-06NA25396 awarded by the U.S. Department of Energy. The government has certain rights in the invention.

### BACKGROUND OF THE INVENTION

1. Field of the Invention

The present invention is related to visual displays, and, more particularly to a presentation device capable of being used at remote locations in conjunction with stereoscopic environments.

2. Background of Invention

For the human visual system, due to the independent visual system for the right eye and the left eye, the image captured by the right eye is different from the one captured by the left eye. Therefore, humans can merge these individual images (parallax images) together and obtain a vision with depth perception. The key to 3D displays is a mechanism to present the left and right images to the corresponding eyes without crosstalk.

Stereoscopic imaging systems have been employed to give a three-dimensional appearance to field sequential images displayed on a video display screen. One form of three-dimensional appearance is created by active stereoscopic glasses that switch between opaque and transmissive optical states to alternately transmit to a viewer left- and right-eye views of a stereoscopic image that is sequentially displayed on the screen. The viewer fuses the separate left- and right-eye images into a single stereoscopic image. A maximum contrast ratio can be achieved by providing maximum output light extinction in the opaque state to block an image to the viewer's eye and maximum light transmission in the transmissive state to convey an image to the viewer's eyes.

The field-sequential stereoscopic display outputs a right image and a left image sequentially, and the left eye and the right eye of the stereoscope are shut synchronized with the right image and the left image. If the switching between left and right eyes is fast enough that human eyes cannot distinguish the change of switching, then the appearance of stereo is generated. In addition, for generating ideal feeling of stereoscopy, the switching between left and right eyes of the stereoscope should be synchronized with the left image and right image on the screen.

A shutter type of liquid crystal shutter glasses (hereinafter referred to as shutter glasses) is useful for 3D stereo viewing. The shutter glasses do not shutter the left eye and right eye by any mechanical shuttering, but shutter by alternately electrically activating an electronic shuttering. One form of glasses has high-speed electronic shutters that open and close in sync with the images on the display. Liquid crystals are used for the shutters because an electronic signal can make the crystal turn instantly from transparent to opaque.

For presentations, a presenter typically will use a laser pointer to point to a presentation item. The conventional laser pointer includes a low power laser that allows the user to shine a concentrated light beam on a specific spot on a presentation item of interest. The conventional portable laser pointer is most commonly used to project a point of light to highlight items of interest during a presentation. A presenter in a 3D visualization facility will often point out features of interest with a conventional laser pointer, but the conventional laser pointer makes a single spot on the display surface, and audience members find it difficult to recognize the object of interest to the presenter.

Accordingly, it would be highly desirable to provide an improved presentation device that acts upon the synch-signal as do the shuttering glasses, and displays two time-sliced beams that are synchronized with each image of the stereo-pair being displayed. The presentation device may also have a controller allowing an operator to interactively vary the divergence of the two beams in order to fine-tune the separation of two spots where the beams hit the display surface so that the apparent spot appears with proper separation (parallax) and appears (to the presenter and members of the audience) to be on the object of interest.

Further objectives and advantages of the present invention will become apparent from a careful reading of a detailed description provided hereinbelow, with appropriate reference to accompanying drawings.

### SUMMARY OF THE INVENTION

It is a general object of the present invention to provide a presentation device configured to control the apparent single spot in the stereoscopic environments in which the above-described disadvantage is eliminated or reduced. The presenter and audience members (who wear the shutter glasses) see an apparent single laser-spot floating in 3D-space on the object that the presenter has selected. The device would operate independently of the graphic system and thus have no impact on performance. A more specific object of the present invention is to provide a laser pointer capable of being used at remote locations in conjunction with stereoscopic environments. The presentation device comprises a light source assembly configured to provide a plurality of visible light beams for pointing the visible light beams at an object; a liquid crystal cell assembly including a pair of optical shutters, the liquid crystal cell assembly selectively transmitting fields of a field sequential image in response to a drive signal wherein each of the visible light beams emitted from the light source assembly passes through a respective optical shutter; a receiver mounted adjacent the liquid crystal cell assembly for receiving a synchronization signal; a drive module coupled to the liquid crystal cell assembly and the receiver for generating the drive signal in response to the synchronization signal and supplying the drive signal to the liquid crystal cell assembly; and a user-operable switch having a first state configured to select operation of the light source assembly. The laser pointer also comprises means for movably adjusting relative positions of emitting points of the visible light beams with respect to one another and means for movably adjusting relative convergence angle of the emitted visible light beams with respect to one another.

Another aspect of the present invention is to provide a method including the steps of: providing a liquid crystal cell assembly including at least two liquid crystal lenses wherein the liquid crystal cell assembly selectively transmits fields of a field sequential image in response to a drive signal; emitting at least two visible light beams from at least two separate and spaced points, for pointing the visible light beam at an object wherein each of the visible light beams emitted from the light source assembly passes through a respective liquid crystal lens; receiving a synchronization signal; and generating a drive signal in response to the synchronization signal and supplying the drive signal to the liquid crystal lenses.

### BRIEF DESCRIPTION OF THE DRAWINGS

These and other features, aspects and advantages of the present invention will become better understood with regard to the following description, appended claims and accompanying drawings where:

FIG. 1 is a pictorial representation of the presentation device of this invention positioned at the transmitting location and utilized in conjunction with a stereoscopic presentation in accordance with an embodiment of the present invention;

FIG. 2 illustrates the signals of the stereo orientation control in accordance with an embodiment of the present invention;

FIG. 3A is a block diagram of a presentation device in accordance with an embodiment of the present invention.

FIG. 3B illustrates an outer configuration of a presentation device in accordance with an embodiment of the present invention.

FIGS. 4A and 4B are diagrams showing horizontal laser tracks according to relative divergence or convergence angle of emitted visible light beams with respect to one another in accordance with an embodiment of the present invention.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein. Like numbers utilized throughout the various figures designate like or similar parts.

### DESCRIPTION OF THE EMBODIMENTS

Preferred embodiments of the present invention will be described below with reference to the accompanying drawings.

As used in this application, the terms “module” and “unit” are intended to refer to, but are not limited to, a software or hardware component, which performs certain tasks. A module or component may advantageously be configured to reside on the addressable storage medium and configured to execute on one or more processors. Thus, a module or component may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

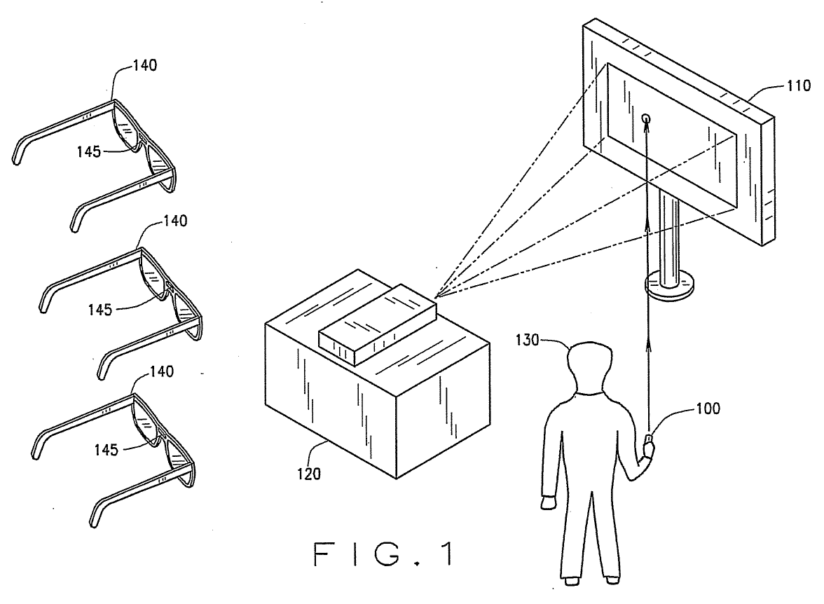

The present invention may be described through the exemplary illustrations set forth in FIGS. 1 through 4. A first embodiment of the presentation invention includes a first portion and a second portion. The first portion of the presentation device includes a first presentation element, for example, a light source element such as a laser pointer element. The laser pointer element includes a laser pointer lens and a laser pointer switch button. The second portion of the presentation device includes a second presentation element. The second presentation element may be an electronic control device. The pointing device element includes one or more pointing device buttons and thumb wheel assembly. The first portion and the second portion generally form a unitary configuration or article (e.g., an apparatus). In one embodiment, the first portion and the second portion may be, for example, physically separate housings. The physically separate portions may be configured to release and re-attach to one another. In yet another embodiment, the first portion and the second portion may be, for example, a single or unitary housing having a first and a second logical portion within the housing.

The first embodiment of the universal presentation device may have a substantially cylindrical-shaped configuration, a bar shaped configuration, an elongated barrel shaped configuration, or a variety of other geometrical configurations that are capable of housing at least a laser pointer element and a pointing device element. Those of skill in the art will recognize that the shape of the presentation device can be ergonomically suited to the human hand such that the device is easy to hold and readily usable.

Reference is now made to FIG. 1 of the drawing. FIG. 1 pictorially represents the transmitting location at which an individual 130 acts as a presenter with which the presentation device 100 of this invention is utilized. At each the transmitting and receiving locations, respectively, a screen 110 is set up in its proper relationship with audiences with optical shutters for viewing three-dimensional stereoscopic images displayed on the screen 110. LCD shutter glasses 140 implicate audiences who wear the optical shutter glasses. In addition, a stereoscopic projector 120 is utilized with screen 110 for projecting stereoscopic images onto the screen 110.

FIG. 1 illustrates a field-sequential stereo display with the shuttering states for the shutter glasses 140. The screen 110 displays in a way following the sequence as left image, right image, left image, . . . , meanwhile the right eye and left eye of the shutter glasses 140 are shut alternately and successively by a synchronizing signal transmitted to a receiver 145. Therefore, viewers wearing the shutter glasses 140 can see the left image with the left eye and can see the right image with the right eye to perceive 3D depth. A liquid crystal shutter system selects fields of a field-sequential stereoscopic image, and a corresponding pulse width encoded synchronization signal is transmitted to a liquid crystal shutter assembly. A drive signal is generated in response to the transmitted synchronization signal, and the drive signal is supplied to the liquid crystal shutter assembly to select fields of the transmitted image. LCD shutter glasses 140 are glasses used in conjunction with computers to create the illusion of a three dimensional image, an example of stereoscopy. Glass containing liquid crystal and a polarizing filter has the property that it becomes dark when voltage is applied, but otherwise is transparent.

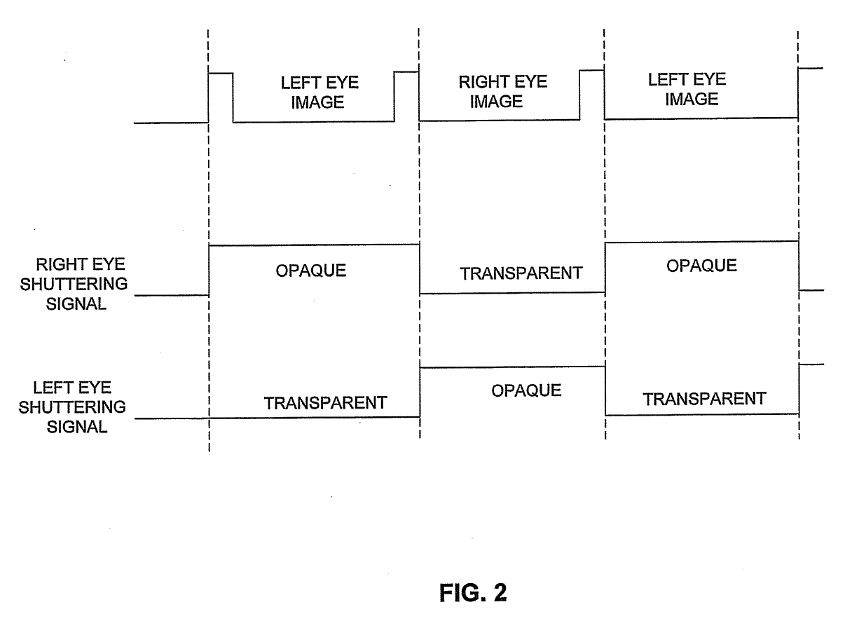

References hereinafter with respect to terms such as “left” and “right” shall be made from the perspective of a user having a presentation device. FIG. 2 shows the timing chart for the shuttering signals of the shutter glasses. The image system generates a synchronizing signal for each image frame. Typical shutter glasses generate shuttering signals according to synchronizing signal 210. As being shown in FIG. 2, when a left eye image is displayed on the screen, the shuttering signal of the right lens is at high level, and the right lens of the shutter glasses is shuttered and opaque by activating LCD. At the same time, the shuttering signal of the left lens is at low level, and the left lens of the shutter glasses is transparent so that a viewer can see the left image with only the left eye. Then, when a right eye image is displayed on the screen, the shuttering signal of the right eye is at low level, and the right lens of the shutter glasses is transparent so that a viewer can see the right image. At the same time, the shuttering signal of left eye is at high level, and the left eye of the shutter glasses is shuttered and opaque. Consequently, by alternately applying shuttering signals to the shutter glasses lenses and displaying individual eye images on the screen, the apparent 3D images can be generated.

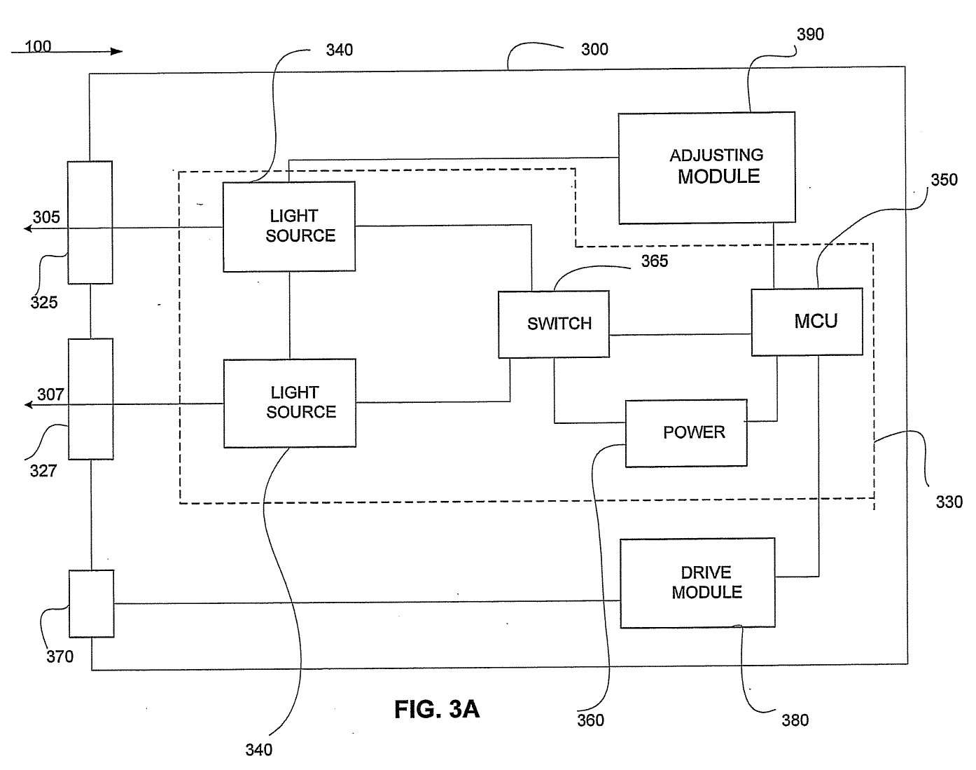

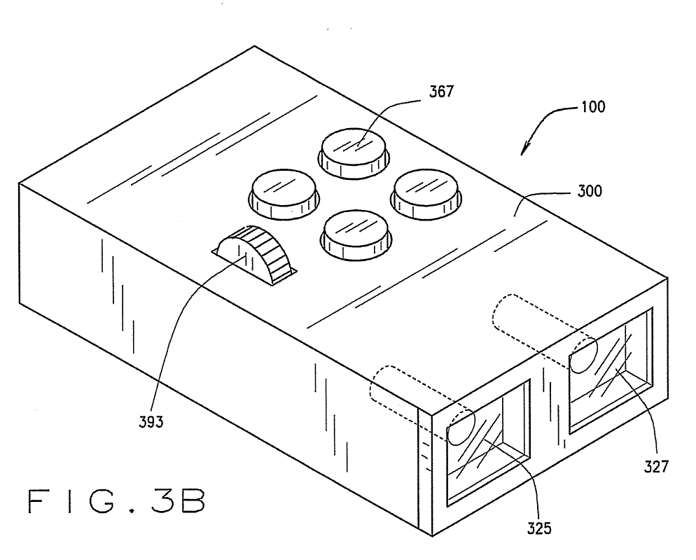

FIGS. 3A and 3B illustrate structures of the presentation device 100. The presentation device 100 of the present invention comprises an external shell body 300, which houses a set of two parallel LCD shutter lenses 325, 327 which permit two coherent light beams such as laser beams 305, 307 to pass therethrough. The beams 305, 307 shine through the shutter lenses 325, 327. In one embodiment, two channels (not shown) are provided in the path of the two projected laser beams, right beam 305 and left beam 307, emanated from the respective light sources 340. The two LCD shutter lenses, right lens 325 and left lens 327, are provided in the front portion of the external shell body 300. The two light sources 340 are properly separated in order to work with the shutter lenses 325, 327. Those of skill in the art will recognize that two light beams can be generated with one light source and the generated beam can be split into two separate light beams. A laser beam generating unit 330 is shown in the rear portion of the shell body 300. The laser beam generating device 330, which is readily available and is a known art in the commercial market, comprises one or more laser beam modules, a microcontroller unit (MCU) 350, and an electric power source 360. The MCU 350 electrically couples with the drive module 380, the switch 365, the shutter lenses 325, 327 and the adjusting module 390. The MCU 350 also communicatively couples with a stereoscopic image generator 120 of FIG. 1 through a wired or wireless transmission. The wireless transmission includes RF or infrared (IR) transmission. Those of skill in the art will recognize other types of wireless transmission for the synchronization signal. The RF unit 370 is a conventional radio frequency receiver that communicates through radio frequency transmission with the stereoscopic image generator 120 having an RF transmitter (not shown).

The power source 360 is a conventional power source unit that provides direct current or alternate current power. For example, the power source 360 may include one or more 1.5-volt battery power cells or a 9-volt battery power cell.

With regard to the laser pointer element, the light sources 340 electrically couple with the switch 365 operated by a switch button 367. The switch 365 couples with the laser pointer switch button (not shown). The laser switch 365 electrically couples the light sources 340 with the power source 360 when the laser beam modules is in an on state, and decouples the light sources 340 from the power source 360 when the laser beam modules is in an off state. In one embodiment, the light sources 340 are conventional laser units that include a conventional laser diode. When the light sources 340 are in an on state, the laser diode generates a visible light beam (or laser beam) that is emitted through the LCD shutter lenses 325, 327. This visible light beam may be shined on an object to point to that object or to an apparent object in 3D space.

Two liquid crystal lenses 325, 327 are mounted in each lens socket of the shell body 300. The liquid crystal lenses 325, 327 are driven by drive signals. Each laser beam 305, 307 is emitted from the respective light source 340, and each passes through the respective channel (not shown) and then the respective LCD shutter lens 325, 327. The right laser beam 305 selectively passes through the right LCD shutter lens 325 and the left laser beam 307 selectively passes through the left LCD shutter lens 327. Referring to FIG. 1, the screen 110 displays in a way following the sequence as left image, right image, left image, . . . , meanwhile the right shutter lens 325 and the left shutter lens 327 are shut alternately and successively by a synchronizing signal. Therefore, the right and left beams 305, 307 cannot pass through the respective right or left shutter lens 325, 327 whenever they are shut alternatively corresponding to a synchronization signal. The MCU 350 electrically couples with the shutter lenses 325, 327 so that it alternately shuts the left and right lenses 325, 327 matching the left light spot to the left stereoscopic image and the right light spot to the right stereoscopic image on the screen. The receiver 370 receives sync information broadcast by transmitter (not shown) and uses this sync information to synchronize the drive signals supplied from drive module 380 to the shutter lenses 325, 327, so that the shutter lenses 325, 327 switch in synchronization with the displayed image field rate. The shutter lenses 325, 327 do not require large liquid crystal panels for switching the polarization of polarized light at field rate. It will be apparent to one of ordinary skill in the art of electrical drive circuit design how to construct a circuit capable of producing a drive signal for driving one of the shutters. In one embodiment, the synchronization signals are encoded in accordance with a pulse width modulation scheme, before they are transmitted from transmitter (not shown) of the stereoscopic image generator 120 to the receiver 370. Finally the light beams 305, 307 are projected outwardly to create a single apparent spot on the stereoscopic images.

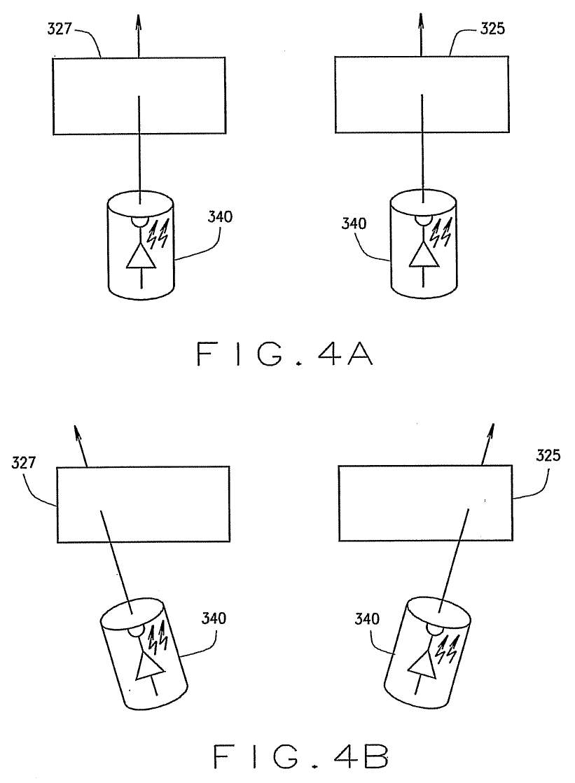

The two light sources 340 are each pivotally moveable in order to enable the operator to adjust the divergence of the beams to control the separation of the spots on the display surface, as shown in FIGS. 4A and 4B. In one embodiment, the adjusting module 390 can allow the light sources 340 to move horizontally, relative to each other. Referring to FIG. 3B, the operator can control these movements as with a thumb wheel 393. The thumb wheel 393 is rotatably mounted to project above the exterior surface of the shell body 300. Rotating the thumb wheel 393, which is electrically coupled with the adjusting module 390, causes a pivotal or horizontal movement of the light sources 340. Pivotal adjustment preferably includes a thumb wheel 393, a stop (not shown), and a drive member such as a screw (not shown). Two light sources 340 are pivotally mounted in spaced relationship. The light sources 340 have associated axes of projection. A drive member is provided to effect relative movement between the axes of the light sources 340. Stop means, which may have a variety of forms by which to limit movement of the drive member, is provided so the drive member has limited movement. Other adjusting means also may be used. To adjust the divergence or convergence angle, a user turns the thumb wheel 393. The movement of the thumb wheel 393 causes the stop means to transition along the screw. In another embodiment, these adjustments can be controlled in mechanical manners. As a result of the pivotal adjustment, spacing between the left spot to left stereoscopic image and the right spot to right stereoscopic image is changed so that illusory spot created by the matched right and left spots points at a different user selected location on a selected three dimensional virtual object of the three-dimensional stereoscopic image. The user can point at a location having a different depth on the three dimensional virtual object of the stereoscopic image by adjusting the divergence or convergence angle between the beams from the right and left light sources 340.

Although a preferred embodiment of the present invention has been described, anyone of ordinary skill in the art to which the invention pertains should be able to understand that a very large number of permutations are possible without departing from the spirit and scope of the present invention, which shall only be defined by the claims appended below.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.”

What is claimed is:

1. A presentation device comprising:
a light source assembly configured to provide a plurality of visible light beams for pointing the visible light beams at an object;
a plurality of optical shutters operable to selectively transmit fields of a field sequential image in response to a drive signal wherein each of the visible light beams emitted from said light source assembly passes through a respective said optical shutter;
a receiver for receiving a synchronization signal;
a drive module coupled to said optical shutters and the receiver, for generating the drive signal in response to the synchronization signal and supplying the drive signal to the optical shutters; and
a user-operable switch having a first state configured to select operation of said light source assembly.

2. The presentation device of claim 1, further comprising means for movably adjusting relative positions of emitting points of said visible light beams with respect to one another.

3. The presentation device of claim 1, further comprising means for movably adjusting relative divergence or convergence angle of said emitted visible light beams with respect to one another.

4. The presentation device of claim 1, wherein each said optical shutter has an optically-transparent state and an optically-opaque state which state is selected by said drive signal.

5. The presentation device of claim 1, wherein each said optical shutter includes an LCD optical shutter.

6. The presentation device of claim 1, wherein said visible light beams are laser beams.

7. The presentation device of claim 1, wherein said user-operable switch has a second state configured to select operation of a single visible light beam for use with a two-dimensional image presentation.

8. The presentation device of claim 1, wherein said object is a projected image.

9. The presentation device of claim 1, wherein said emitted beams point at user selected location on a selected volumetric virtual image of said object.

10. A presentation device comprising:
two light sources, each of the two light sources being configured to provide a visible light beam and operable for pointing a respective visible light beam at an object;
two liquid crystal shuttering lenses, each of the liquid crystal shuttering lenses being operable to selectively transmit fields of a field sequential image in response to a drive signal wherein each of the visible light beams selectively passing through a respective said liquid crystal shuttering lens;
a receiver for receiving a synchronization signal;
a drive module coupled to said two liquid crystal shuttering lenses and the receiver, for generating the drive signal in response to the synchronization signal and supplying the drive signal to said liquid crystal shuttering lenses; and
a user-operable switch having a first state configured to select operation of said light sources.

11. The presentation device of claim 10, further comprising means for movably adjusting relative positions of emitting points of said visible light beams with respect to one another.

12. The presentation device of claim 10, further comprising means for movably adjusting relative divergence or convergence angle of said emitted visible light beams with respect to one another.

13. The presentation device of claim 10, wherein each said two liquid crystal shuttering lenses has an optically-transparent state and an optically-opaque state which state is selected by said drive signal.

14. The presentation device of claim 10, wherein said visible light beams are laser beams.

15. The presentation device of claim 10, wherein said user-operable switch has a second state configured to select operation of a single visible light beam for use with a two-dimensional image presentation.

16. The presentation device of claim 10, wherein said object is a projected image.

17. The presentation device of claim 10, wherein said emitted beams point at user selected location on a selected volumetric virtual image of said object.

18. The presentation device of claim 10, further comprising a stereoscopic projector wherein the stereoscopic projector displays stereoscopic images.

19. A method for optically positioning a three-dimensional image for a theatrical viewing audience, the method comprising:
providing optical shutters wherein the optical shutters selectively transmit fields of a field sequential image in response to a drive signal;
emitting at least two visible light beams from at least two separate and spaced points, for pointing the visible light beams at an object wherein each of the visible light beams emitted from a light source passing through a respective said optical shutter;
receiving a synchronization signal; and
generating a drive signal in response to the synchronization signal and supplying the drive signal to said optical shutters.

20. The method of claim 19, further comprising:
producing at least one stereoscopic image using a three dimensional image generating system, wherein the emitted beam points at user selected location on a selected volumetric virtual object of said three dimensional image.

21. The method of claim 19, further comprising movably adjusting relative positions of emitting points of said visible light beams with respect to one another.

22. The method of claim 19, further comprising movably adjusting relative divergence or convergence angle of said emitted visible light beams with respect to one another.

23. The method of claim 19, wherein each said optical shutter has either an optically transparent state or an optically opaque state which is selected by said drive signal.

24. The method of claim 19, wherein each said optical shutter is an LCD optical shutter.

25. The method of claim 19, wherein said visible light beams are laser beams.
